(19) United States
(12) Patent Application Publication
(10) Pub. No.: US 2006/0089781 A1
(43) Pub. Date: Apr. 27, 2006

(54) Fuel consumption estimating unit of vehicle

(75) Inventors: Tasuku Sato, Tokyo (JP); Masayuki Kayano, Tokyo (JP); Shogo Matsuura, Tokyo (JP)

Correspondence Address: ROSSI, KIMMS & McDOWELL LLP., P.O. BOX 826, ASHBURN, VA, 20146-0826, US

(73) Assignee: Mitsubishi Fuso Truck and Bus Corporation, Minato-ku (JP)

(21) Appl. No.: 11/258,411

(22) Filed: Oct. 25, 2005

(30) Foreign Application Priority Data
Oct. 25, 2004 (JP) 2004-309690

(51) Int. Cl. G06G 7/70; G06F 19/00

(52) U.S. Cl. 701/103; 701/110

(57) ABSTRACT

Parameters which change depending on driving method of a vehicle driver are inputted to a fuel consumption estimation model. This fuel consumption estimation model estimates fuel consumption of a vehicle based on the parameter. The fuel consumption of a vehicle estimated by the fuel consumption estimation model is outputted to an output portion.

### CROSS-REFERENCE TO RELATED APPLICATIONS

This application is based upon and claims the benefit of priority from prior Japanese Patent Application No. 2004-309690, filed Oct. 25, 2004, the entire contents of which are incorporated herein by reference.

### BACKGROUND OF THE INVENTION

1. Field of the Invention

The present invention relates to a fuel consumption estimating unit capable of estimating fuel consumption.

2. Description of the Related Art

The fuel consumption of vehicle is an important matter for a vehicle driver or a vehicle owner and the vehicle driver can pay attention for driving with as small fuel consumption as possible. It has been well known that this fuel consumption is largely affected by various factors such as the crowded condition of a road traveled by a vehicle, quantity of intersections, quantity of curves, number of temporary stops, weather condition, number of passengers on the vehicle, cargo loading condition, engine specification and the like as well as the driving operation (driving method) by the vehicle driver.

Therefore, when fuel consumption is notified to a vehicle driver to urge him to pay attention to vehicle driving with an excellent fuel consumption, for example if that fuel consumption is excellent, he cannot judge whether the fuel consumption is favorable because his driving operation is good or for other factors. Conversely, even if the fuel consumption is wrong, he cannot judge whether or not the reason is due to the driving operation by the vehicle driver.

That is, the fuel consumption depending on the driving operation of the vehicle driver is not made evident.

### BRIEF SUMMARY OF THE INVENTION

An object of the present invention is to provide a fuel consumption estimating unit capable of estimating an inherent fuel consumption from viewpoints of the driving operation of the vehicle driver.

According to one aspect of the present invention, there is provided a fuel consumption estimating unit of vehicle comprising: a fuel consumption estimation model configured to estimate a fuel consumption of vehicle with parameters which change depending on the driving method of a vehicle driver inputted; and an output portion configured to output the fuel consumption of the vehicle estimated by the fuel consumption estimation model.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram for explaining the principle of a fuel consumption estimating unit of vehicle according to an embodiment of the present invention;

FIG. 2 is a block diagram for explaining a method for creating an estimation model for estimating an ideal fuel consumption according to the embodiment of the present invention;

FIG. 3 is a block diagram showing an estimation model for estimating a fuel consumption inherent of vehicle driver based on a vehicle driver's driving method, according to the same embodiment;

FIG. 4 is a diagram of fuel consumption inherent of drivers A, B, C estimated based on the estimation model of the same embodiment;

FIG. 5 is a schematic diagram of a truck employing the fuel consumption estimating unit of vehicle according to the same embodiment;

FIG. 6 is a diagram showing an error in case of estimating the fuel consumption inherent of vehicle driver based on vehicle driver's driving method by using various analysis methods of the same embodiment;

FIG. 7 is a graph showing an error in case of estimating the fuel consumption inherent of vehicle driver based on vehicle driver's driving method by using various analysis methods of the same embodiment; and

FIG. 8 is a diagram showing an example of another truck employing the fuel consumption estimating unit of vehicle according to the present invention.

### DETAILED DESCRIPTION OF THE INVENTION

Hereinafter an embodiment of the present invention will be described with reference to the accompanying drawings.

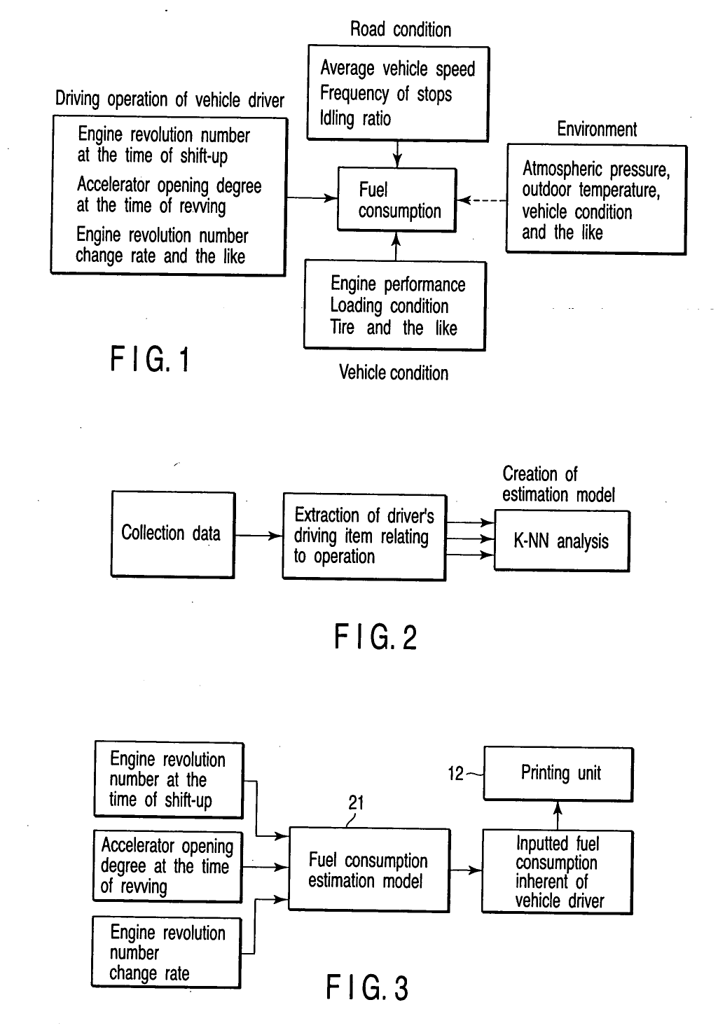

First, factors which affect the fuel consumption of vehicle will be described with reference to FIG. 1. The factors which affect the fuel consumption of vehicle can be largely classified into road condition, vehicle driver's driving operation (driving method), vehicle condition and environment.

As parameters which change depending on the vehicle driver's driving method, engine revolution number Nsft at the time of shift-up, accelerator opening degree θk at the time of revving and engine revolution number change rate Nv are available.

These parameters have a correlation with fuel consumption. For example, if the engine revolution number Nsft at the time of shift-up is high, this results in worsening of the fuel consumption. If the accelerator opening degree θ at the time of revving is large, this results in worsening of the fuel consumption. Further, if the engine revolution number change rate Nv at the time of rapid acceleration is high, this results in worsening of the fuel consumption.

As parameters relating to the road condition, average vehicle speed and frequency of stops are available.

As parameters relating to the vehicle condition, engine performance (engine displacement and the like), loading condition, tires and the like are available.

As parameter relating to the environment, atmospheric pressure, outdoor temperature, vehicle condition and the like are available.

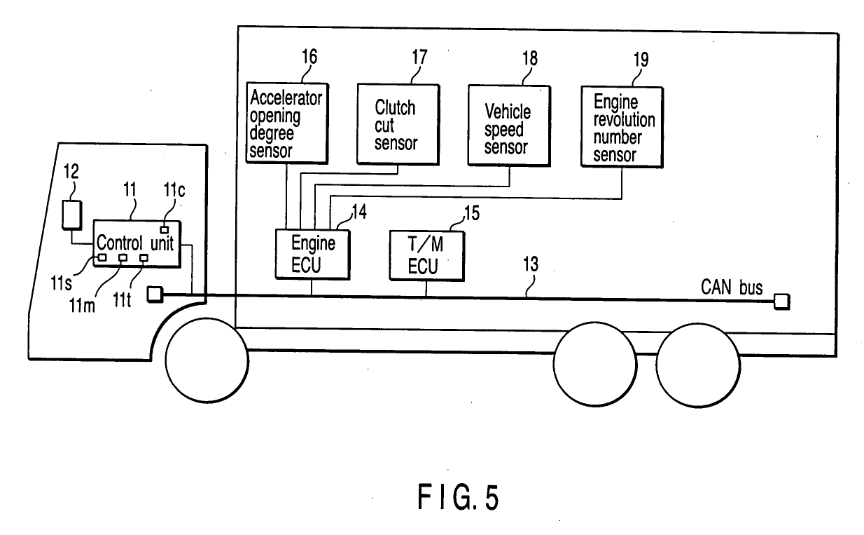

Next, the system configuration of a truck loaded with the fuel consumption estimating unit of vehicle will be described with reference to FIG. 5.

In FIG. 5, reference numeral 11 denotes a control unit of the fuel consumption estimating unit of the present invention. This control unit 11 is constituted of, for example, a microprocessor, which comprises a memory 11m for memorizing various kinds of data, a clock circuit 11c and a timer 11t. A display unit 12 is connected to this control unit 11.

The control unit 11 is connected to an engine ECU (electronic control unit) 14 and a transmission (T/M) ECU (electronic control unit) 15 via a control area network (CAN) bus 13. The control unit 11, the engine ECU 14 and the transmission ECU 15 send/receive various data by communication via this CAN bus 13.

An accelerator opening degree sensor 16 for detecting an accelerator opening degree θ, a clutch connection/disconnection sensor 17 for detecting connection/disconnection of a clutch (not shown), a vehicle speed sensor 18 for detecting a vehicle speed V and an engine revolution number sensor 19 for detecting an engine revolution number Ne are connected to the engine ECU 14.

The transmission ECU 15 outputs a shift-up signal or a shift-down signal to a transmission (not shown).

The control unit 11 receives a vehicle speed V sent from the vehicle speed sensor 18 via the engine ECU 14 in real time.

Further, the control unit 11 obtains shift-up information from the transmission ECU 15. That is, the control unit 11 acquires an engine revolution number sent from the engine revolution number sensor 19 via the engine ECU 14 so as to obtain the engine revolution number Nsft at the time of shift-up. In the meantime, the shift position may be determined depending on the vehicle speed V detected by the vehicle speed sensor 18, clutch connection/disconnection detected by the clutch connection/disconnection sensor 17, gear ratio and the like.

The control unit 11 acquires an accelerator opening degree θk at the time of revving by obtaining an accelerator opening degree θk sent from the accelerator opening degree sensor 16 via the engine ECU 14. The “revving” mentioned here refers to a condition in which the vehicle speed V detected by the vehicle speed sensor 18 is substantially zero while the engine revolution number Ne detected by the engine revolution number sensor 19 is an idling revolution number or more.

Further, the control unit 11 acquires an engine revolution number Ne from the engine ECU and then, an engine revolution number change rate Nv is obtained by differentiating this engine revolution number Ne in terms of time.

The functional configuration of an embodiment of the present invention is shown in FIG. 3. In the control unit 11, the engine revolution number Nsft at the time of shift-up, the accelerator opening degree θk at the time of revving and the engine revolution number change rate Nv, acquired according to the aforementioned method, are inputted to a fuel consumption estimation model 21. The fuel consumption estimation model 21 estimates fuel consumption based on these inputted parameters. Here, the fuel consumption estimation model 21 is modeled to automatically output an estimated fuel consumption according to a predetermined algorithm corresponding to a combination of the inputted parameters. A method for this modeling (method for creating a model) will be described later.

Fuel consumption (fuel consumption inherent of a vehicle drier based on the inputted parameters) estimated by the fuel consumption estimation model 21 is sent to a printing unit 12 at a predetermined timing and outputted to paper. In the meantime, this output timing is permitted to be set up appropriately corresponding to a necessity, for example, when a vehicle driver requires or when the vehicle engine is stopped. This display may be made through a display unit installed on a vehicle instead of the printing unit 12.

A method for creation of the fuel consumption estimation model will be described with reference to FIG. 2. This estimation model 21 is created as follows.

(1) Extracting parameters which change depending on the driving operation by a vehicle driver when various vehicle drivers drive a truck on various road conditions.

(2) Measuring and recording a real fuel consumption at this time.

According to this embodiment, the engine revolution number Nsft at the time of shift-up, the accelerator opening degree θk at the time of revving and engine revolution number change rate Nv are selected as parameters which change depending on the driving operation by the vehicle driver.

(3) An estimation model 21 is created using K-nearest neighbor K-NK analysis based on the extracted parameters and recorded real fuel consumption.

Because the estimation model creation method using this K-NN analysis is a well known method, description thereof is omitted here. In the meantime, this estimation model 21 is loaded on the control unit 11.

Next, the operation of the present invention will be described by taking an example in which a truck loaded with the fuel consumption estimating unit of this embodiment is driven on three kinds of road conditions by vehicle drivers A, B, C.

First, the vehicle drivers A, B, C are made to drive on a first road condition. During traveling on the first road condition, parameters which change depending on the driving operation by the vehicle driver (engine revolution number Nsft at the time of shift-up, accelerator opening degree θk at the time of revving and engine revolution number change rate Nv) are memorized in the memory 11m of the control unit 11. A fuel consumption inherent of the driving operation by the vehicle driver is estimated by inputting these into the estimation model 21.

Then, with the estimated fuel consumption memorized in the memory 11m, it is outputted to paper through the printing unit 12 as required.

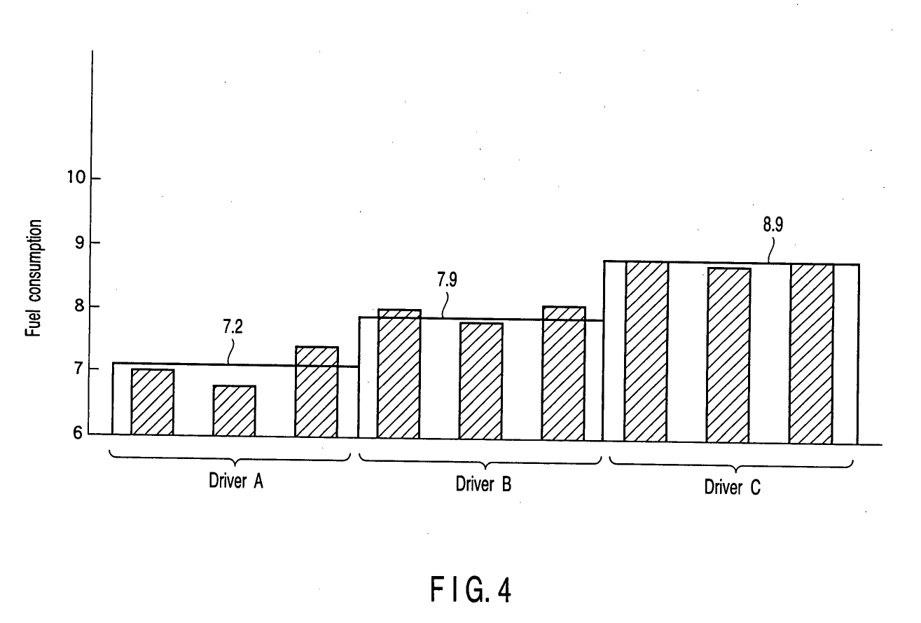

Next, by making the vehicle drivers A-C on the second road condition and the third road condition likewise, fuel consumptions inherent of the driving operations of the vehicle drivers A-C are estimated and memorized into the memory 11m. Alternatively, it is outputted to paper through the printing unit 12. In the meantime, the first-third road conditions are road conditions completely different from one another. For example, the first road condition is a jammed road, the second road condition is an empty linear flat road and the third road condition is a mountainous road with many curves or the like. FIG. 4 shows the fuel consumption inherent of the vehicle drivers A-C memorized in the memory 11m or outputted to paper.

In FIG. 4, bar graph on the left side indicates fuel consumption by each vehicle driver estimated under the first road condition, bar graph in the middle indicates fuel consumption estimated under the second road condition and bar graph on the right side indicates fuel consumption estimated under the third road condition.

Then, an average value of the fuel consumptions under the first-third road conditions by the vehicle driver A is “7.2”, an average value of the fuel consumptions under the first-third road conditions by the vehicle driver B is “7.9” and an average of the fuel consumptions under the first-third road conditions by the vehicle driver C is “8.9”, thereby confirming that the fuel consumptions by the same vehicle driver indicate a substantially constant value although the road condition differs largely.

As evident from FIG. 4, it can be confirmed that the fuel consumption inherent of the driving operation of the vehicle driver B is better than that of the vehicle driver A and that of the vehicle driver C is better than that of the vehicle driver B. That is, the driving operation can be evaluated objectively depending on whether or not the fuel consumption by the driving operation of each vehicle driver is excellent.

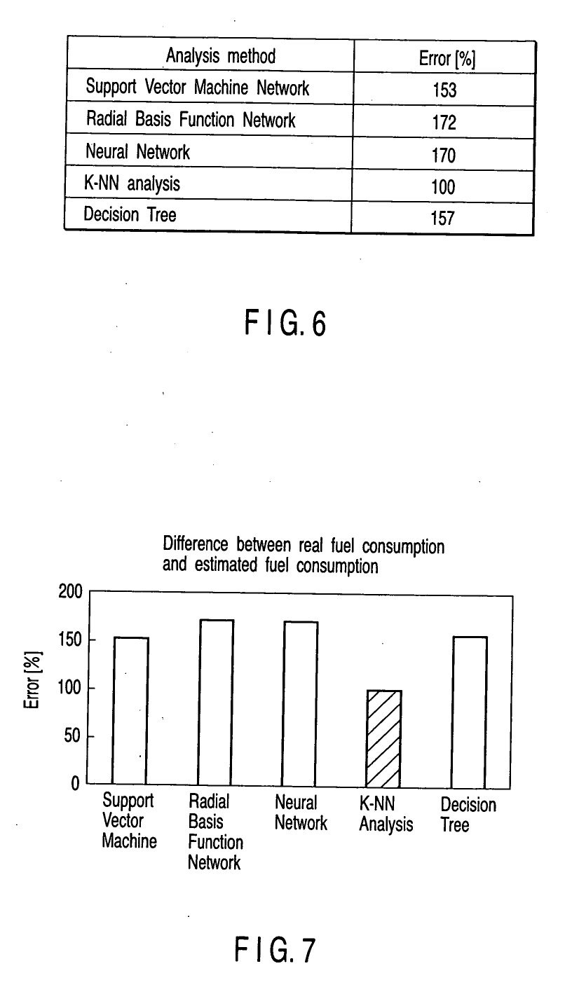

Although according to the above-described embodiment, the K-NN analysis is used as a fuel consumption estimation model, the method which can be applied to the present invention is not restricted to this method. Uses of Support Vector Machine, Radial Basis Function Network, Neutral Network, Decision Tree and the like are included in the technical scope of the present invention. As for error between the real fuel consumption and estimated fuel consumption of each method, among experiments conducted by this inventor, that based on data analysis using the K-NN analysis had the least error as shown in FIGS. 6, 7.

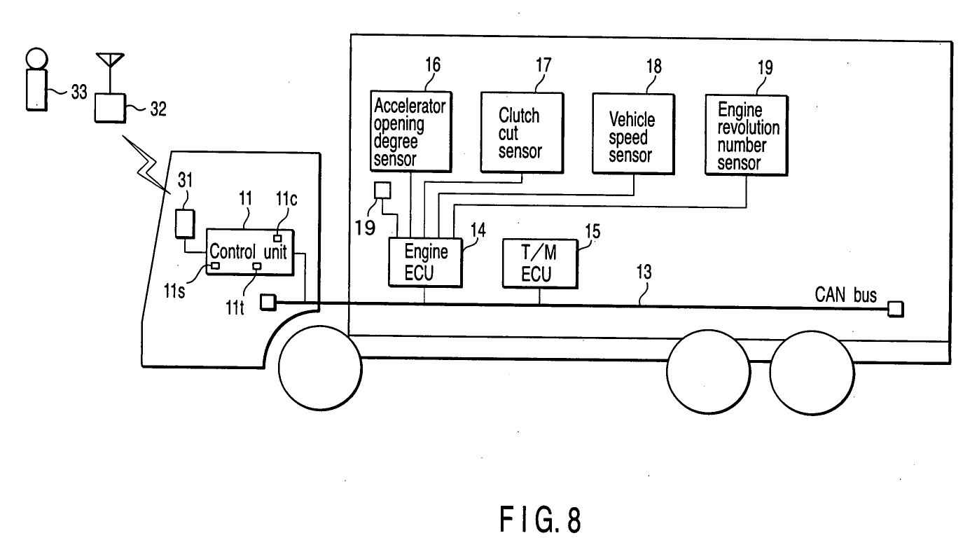

Although the above embodiment adopts the configuration shown in FIG. 5 as the system configuration of a truck, it is permissible to adopt the system configuration of FIG. 8 as well as FIG. 5. In the truck shown in FIG. 8, a sending unit 31 is connected to the control unit 11 and parameters (engine revolution number Nsft at the time of shift-up, accelerator opening degree θk at the time of revving, engine revolution number change rate Nv) which change depending on the driving operation of each vehicle driver, stored in the memory 11m of the control unit 11 and real fuel consumption are sent to an outside receiving unit 32 by radio. Consequently, a controller 33 receives the parameters (engine revolution number Nsft at the time of shift-up, accelerator opening degree θk at the time of revving and engine revolution number change rate Nv), which change depending on the driving method of a vehicle driver and the real fuel consumption data by means of the receiving unit 32 so as to obtain an estimated fuel consumption inherent of the vehicle driver.

The parameters which change depending on the driving method of the vehicle driver are not restricted to those exemplified in the above described embodiment, and it is permissible to adopt other parameter to the present invention as long as it changes depending on the driving method of the vehicle driver, for example, a time in which a clutch is kept pressed, a time in half clutch state and the like.

Although according to the above embodiment, the fuel consumption is printed out from the printing unit 12 as shown in FIG. 3, it may be outputted to a recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel consumption estimating unit of vehicle comprising:
a fuel consumption estimation model configured to estimate a fuel consumption of vehicle with parameters which change depending on the driving method of a vehicle driver inputted; and
an output portion configured to output the fuel consumption of the vehicle estimated by the fuel consumption estimation model.

2. The fuel consumption estimating unit of vehicle according to claim 1, wherein
the parameters include at least an engine revolution number of the vehicle when the vehicle is shifted up, an accelerator opening degree when the vehicle is revving and an engine revolution number change rate of the vehicle, and
the fuel consumption estimation model estimates the fuel consumption of the vehicle with at least the engine revolution number, the accelerator opening degree, the engine revolution number change rate inputted.

3. The fuel consumption estimating unit of vehicle according to claim 1, wherein the output portion outputs the fuel consumption of the vehicle estimated by the fuel consumption estimation model by means of a printing unit installed on the vehicle.

4. The fuel consumption estimating unit of vehicle according to claim 1, wherein the output portion displays the fuel consumption of the vehicle estimated by the fuel consumption estimation model on a display unit installed on the vehicle.
